(19) United States
(12) Patent Application Publication
(10) Pub. No.: US 2023/0235231 A1
(43) Pub. Date: Jul. 27, 2023

(54) ALKYLPHENOL-FREE REACTIVE NONIONIC SURFACTANT, PROCESS TO OBTAIN THE ALKYLPHENOL-FREE REACTIVE NONIONIC SURFACTANT, LATEXES OBTAINED BY EMULSION POLYMERIZATION, WATER-BASED COATING COMPOSITION WITH HIGH WATER RESISTANCE, AND USE OF WATER-BASED COATING COMPOSITION

(71) Applicant: Oxiteno S.A. Indústria e Comércio, Sâo Paulo (BR)

(72) Inventors: Juliane Pereira SANTOS, Santo André (BR); Bruno Soares DÁRIO, Osasco (BR); Camila Oliveira GUIMARÃES, São Paulo (BR); Marilia Aparecida DE ANDRADE, São Caetano do Sul (BR); Natalia Freitas DE PAULA, São Caetano (BR); Robson Andre PAGANI, Santo André (BR); Silmar Balsamo BARRIOS, São Paulo (BR)

(73) Assignee: Oxiteno S.A. Indústria e Comércio, São Paulo (BR)

(21) Appl. No.: 17/923,302

(22) PCT Filed: May 3, 2021
(86) PCT No.: PCT/BR2021/050185

§ 371 Date: Nov. 4, 2022

(30) Foreign Application Priority Data
May 5, 2020 (BR) BR102020008912-9

(51) Int. Cl. C09K 23/36; C08F 2/30; C08F 2/26

(52) U.S. Cl. CPC C09K 23/36; C08F 2/30; C08F 2/26

(57) ABSTRACT

This invention deals with a new alkylphenol ethoxylated free (APE-free) reactive nonionic surfactant with terminal unsaturation in the hydrophobic part comprising at least one of monoesters and diesters and a process to obtain the APE-free reactive nonionic surfactant comprising the alkoxylation step of fatty acid with terminal unsaturation or direct esterification of fatty acid with terminal unsaturation and glycol derivative. Furthermore, emulsion polymerized latexes are disclosed, which are polymerized with an anionic surfactant and a reactive nonionic surfactant of this invention. Latexes prepared according to this invention generated water-based coating compositions with high water resistance.

### FIELD OF INVENTION

This invention comprises water-based coating compositions with water high resistance, latexes polymerized with reactive nonionic surfactants obtained through emulsion polymerization, emulsion polymerization process used to generate the latexes, and synthesis of the ethoxylated alkylphenol-free reactive nonionic surfactants used in the emulsion polymerizations.

Invention Fundamentals

Water-based coatings have been given much attention because they show a lower environmental impact when compared to solvent-based coatings and because they are economically viable.

Most water-based coatings contain a dispersion of polymer particles in water stabilized by surfactants, known as latex, in the singular, or latexes, in the plural.

Latexes are obtained preferably by emulsion polymerization and their main properties are:
monomeric composition, which defines their glass transition temperature (Tg) and ability to form film under various temperature and moisture conditions, and
and particle size distribution.

Conventional market latexes typically have particles with average size between 50 and 500 nm and Tg from −40 to 90° C.

Latex is a component of the water-based coating formulation of paramount importance, being accountable for the formation of films or continuous and homogeneous coating films presenting appearance, mechanical properties, water resistance, resistance to weathering, and resistance to other external factors suitable to each application.

Water-based coatings are used in several applications, including architectural paints, adhesives, paper, leather and fabrics. In order to develop an emulsion polymerization process and consequently a stable latex, the selection of surfactants is of utmost importance.

Surfactants have the challenging task of controlling particle nucleation at the beginning of polymerization, particle stability and clot formation in the reactor throughout the polymerization. Besides, the surfactants control the particle size, mechanical stability, electrolyte stability, freeze-thaw stability and final latex shelf-life.

The most commonly used surfactants in the emulsion-polymerization are anionic and nonionic. Normally, a single surfactant is not enough to generate a latex with mechanical stability, stability to electrolytes and stability to cooling and heating cycles, also known as freeze-thaw stability.

The conventional surfactants used in emulsion polymerization have a hydrophobic and a hydrophilic portion, and they physically adsorb on the surface of the dispersed phases present throughout the polymerization, such as monomer droplets emulsified in water and polymer particles dispersed in water, as well as the on the surface of polymer particles dispersed in water from the final latex.

Also, the conventional surfactants impact the latex film formation and the properties of water-based coating films.

Usually, the latex film formation comprises three stages: Stage I: evaporation of water and packaging of particles. At this stage the surfactants remain adsorbed to the particles. The film obtained at this stage is not continuous and shows whitish and brittle appearance.

Stage II: particle deformation if the wet polymer Tg or minimum film forming temperature (MFFT) is lower than the room temperature and water evaporation. The resulting film is continuous, transparent and homogeneous, but it shows low mechanical resistance. In addition, at this stage the surfactants remain in the deformed particles interstices resulting in films with low water-resistance.

Stage III: if the temperature of the medium is higher than the dry polymer Tg there is interdiffusion of the polymeric chains from one particle to the other, known as coalescence, accompanied by the disappearance of the particle domains. Simultaneously, the migration of surfactants to polymer-air and polymer-substrate interfaces and segregation of surfactants forming hydrophilic domains also occur. These hydrophilic domains are pathways for water percolation in the film.

The migration of surfactants to the interfaces and hydrophilic domain formation are the main causes of low water resistance and low durability of water-based coatings. This is the main limitation of water-based coatings as compared to solvent-based coatings, constraining the use of water-based coatings in more demanding applications, e.g. in environments with high relative humidity requiring high water resistance coatings.

A potential solution to this problem of low water resistance of water-based coatings is the use of reactive surfactants in emulsion polymerization. The use of such reactive surfactants in emulsion polymerization ensures that the surfactants are covalently bonded to the polymer, avoiding their migration and segregation throughout the film.

That strategy allows that at least part of the conventional surfactants used in water-based coating formulations is replaced by reactive surfactants improving the water resistance of the final coatings. Such improvement in the water resistance of the coatings can be evidenced by the increased wet scrub resistance of coating formulations, especially of the paint formulations.

The use of reactive surfactant is also interesting from an environmental point of view, since the conventional surfactants are removed from coatings applied outdoors by rainwater and taken into the environment while the surfactants incorporated into the polymer are not removed by water and, consequently, they do not run into the environment.

Some prior art documents describe the use of reactive surfactants, as shown below.

The US patent Application U.S. Pat. No. 5,162,475 A teaches latexes polymerized with surfactants derived from butoxylated and ethoxylated allyl alcohol applied to textile coatings. This document demonstrates that natural and synthetic fabrics treated with the latexes polymerized with reactive surfactants have high hardness and are more hydrophobic than the fabrics treated with conventional surfactants.

The US patent Application US 2019/0144584 A1 describes latexes polymerized with monoesters of ethoxylated methanol and 9-decenoic acid used as a reactive surfactant and compositions formulated with such latexes. This invention demonstrates, from the examples, that the reactive surfactants obtained have a low foaming potential, have a lower viscosity than analogue decanoic acid and they can be used in emulsion polymerization. No evidence regarding the effect of reactive surfactants on the properties of latexes and compositions containing these latexes has been presented.

According to the document US 2009/0118397 A1, it seeks protection for coating compositions containing latex and a reactive surfactant based on esters of polyglycerol and unsaturated fatty acids, preferably oleic acid. The reactive surfactants are not used in the emulsion polymerization of latexes but are added to the coating formulation and are expected to react with the surface of the latexes through oxidative curing reactions. Water resistance of the paints accessed through wet scrub resistance testing did not allow the conclusion that the reactive surfactant reacted with the polymer during the paint drying and improved the paints wet scrub resistance since, from the four paint formulations evaluated, only one paint formulation containing the reactive surfactant showed superior wet scrub resistance as compared to the paint containing the conventional surfactant, and all the other paint formulations showed similar wet scrub resistance as compared to the paint containing the conventional surfactant.

The patent Application US 2014/0249272 A1 comprises reactive surfactants free of alkylphenol ethoxylated (APE) having a side allylic group in the hydrophobic portion of the surfactant that do not negatively interfere with the conversion and copolymerization of styrene, since this is a limitation of the APE-free reactive surfactants. According to this document, only APE reactive surfactants allowed conversion and copolymerization of styrene. It is further reinforced that the main property of water-based coatings polymerized with reactive surfactants is the water resistance and demonstrates the water resistance of latex films polymerized with their reactive surfactants through the whitening evaluation of latex films immersed in water.

However, there is still a technical requirement of developing new latexes polymerized with special reactive nonionic surfactants with unsaturation at the beginning of the hydrophobic chain that allow improvement of the water resistance of coating formulations. Besides, the coating formulations containing such latexes should show excellent colloidal stability forming less clot in the reactor, in the filtration step and in the latex neutralization step.

INVENTION SUMMARY

This invention comprises compositions of water-based coatings with high water resistance, latexes polymerized with reactive surfactants, emulsion polymerization process used to generate the latexes, and synthesis of the reactive surfactants used in emulsion polymerizations.

SHORT PICTURE DESCRIPTION

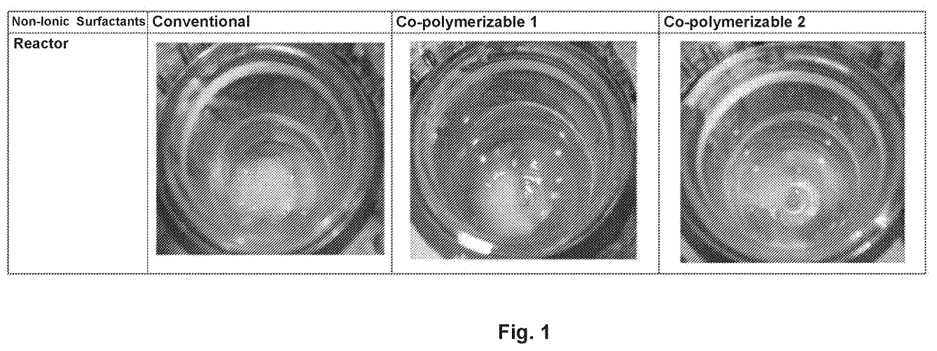

FIG. 1 shows curves of surface tension as a function of surfactant concentration of different nonionic surfactants.

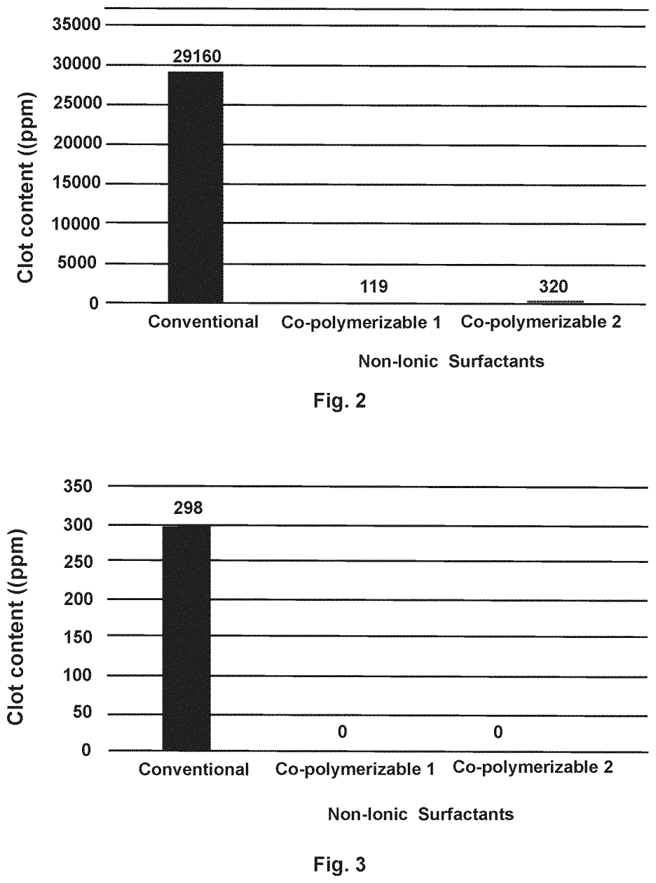

FIG. 2 shows photographs demonstrating the effect of different nonionic surfactants on clot formation in the reactor.

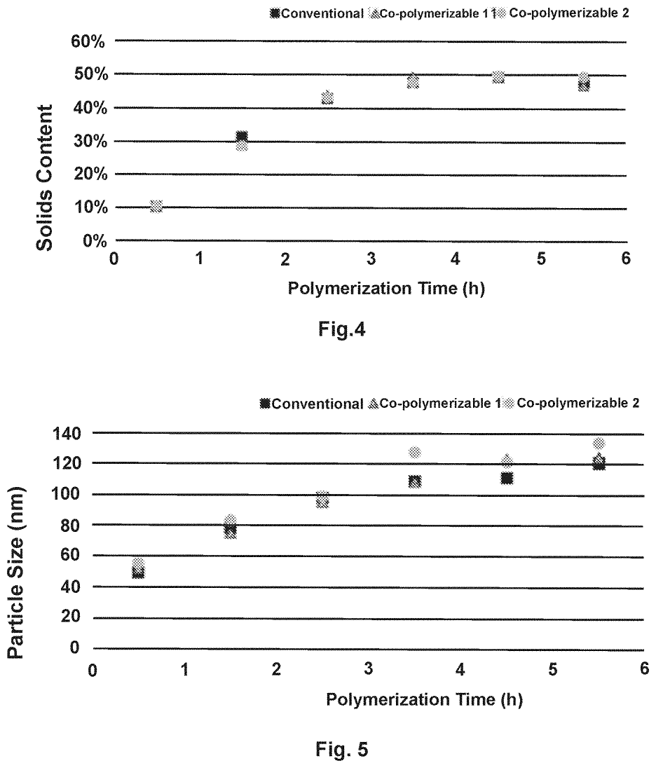

FIG. 3 shows the clot content of the latexes polymerized with different nonionic surfactants obtained during filtration.

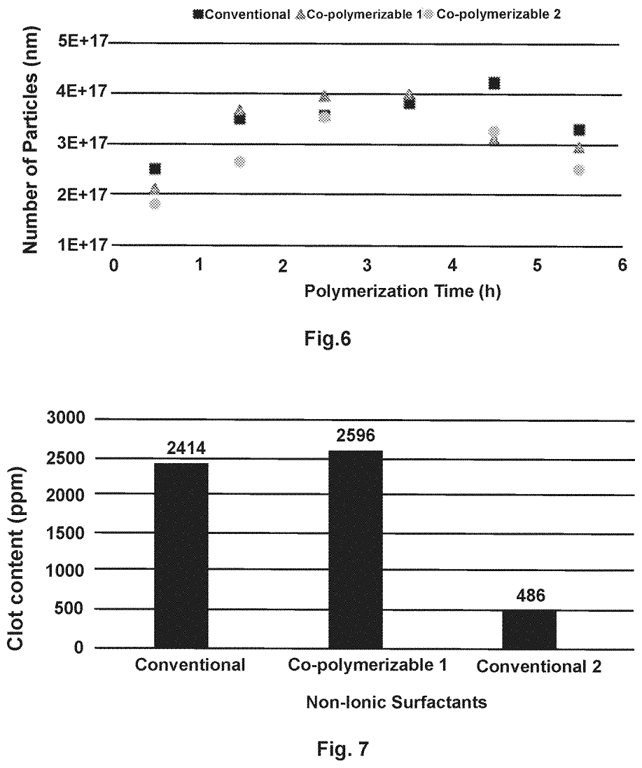

FIG. 4 shows the content of clot formed during the latex neutralization step.

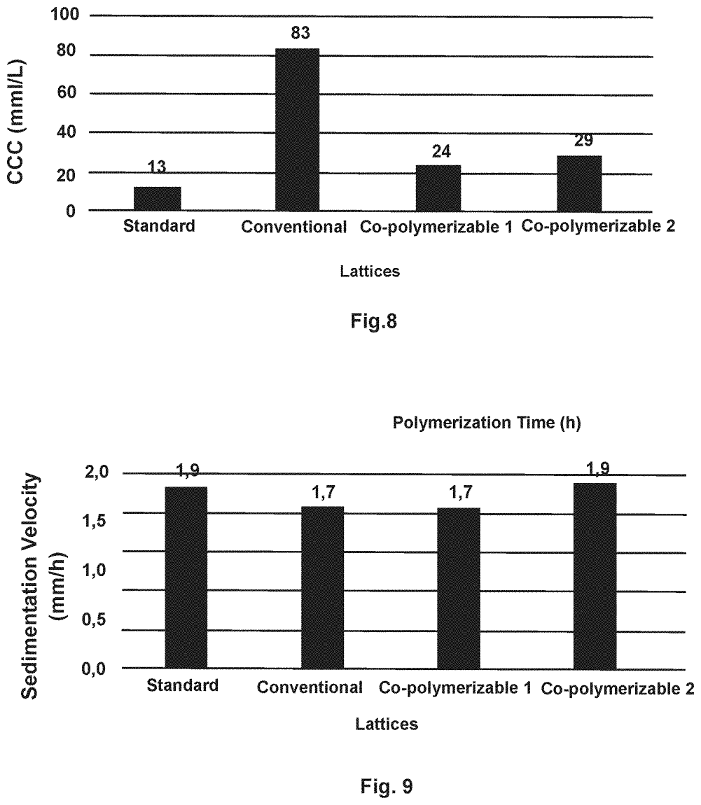

FIG. 5 shows a chart with the evolution of the solids content along the polymerization.

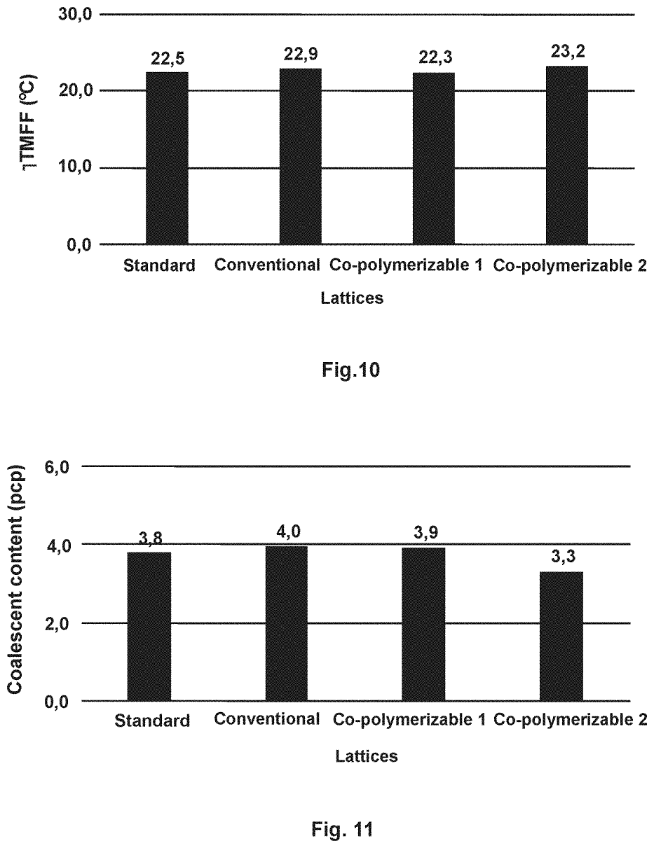

FIG. 6 shows a chart with the particle size evolution along the polymerization.

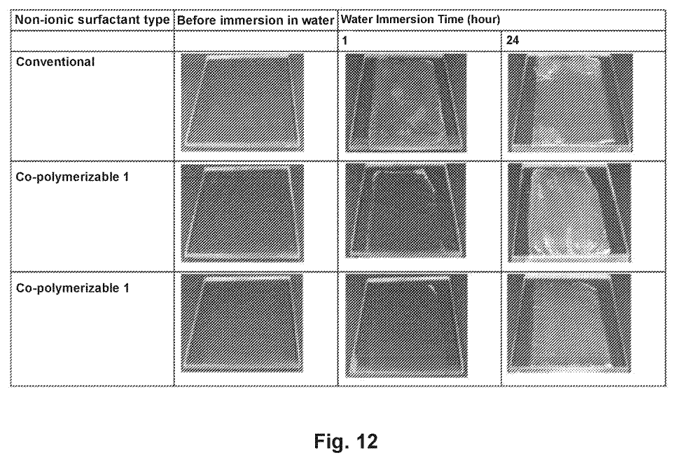

FIG. 7 shows a chart with the evolution of the number of particles along the polymerization.

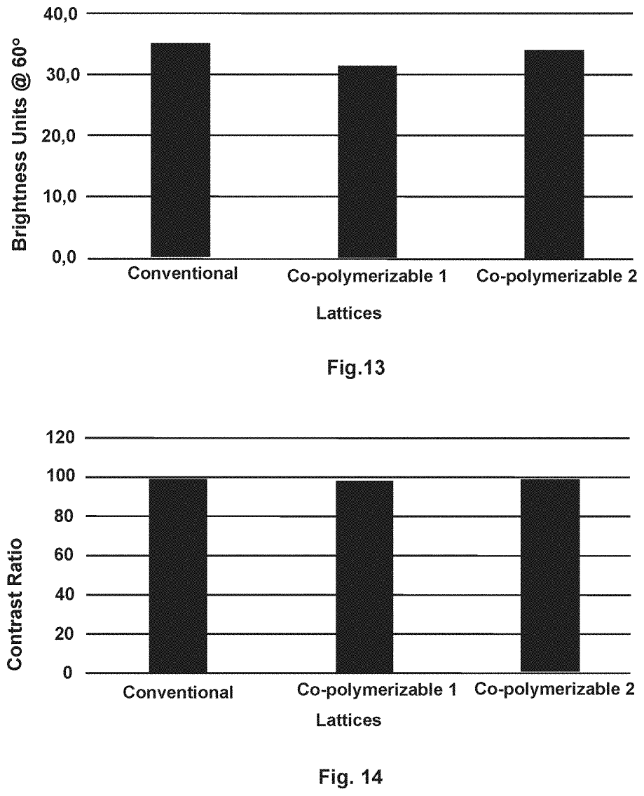

FIG. 8 shows a chart with the effect of different nonionic surfactants on the mechanical stability of the neutralized latexes.

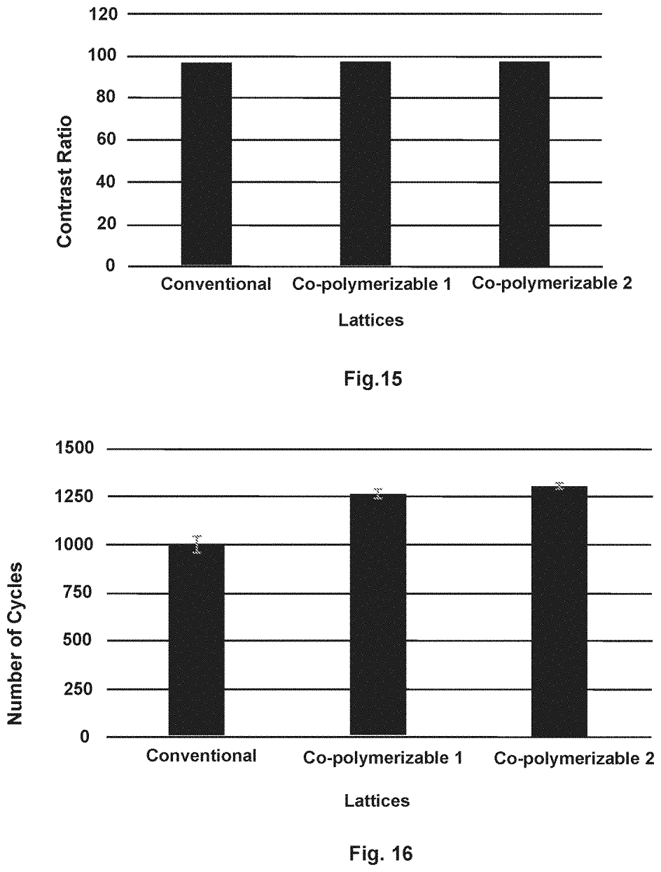

FIG. 9 shows the critical coagulation concentration of latex ACRONAL® BS700 and latexes polymerized in examples 9, 10, and 11.

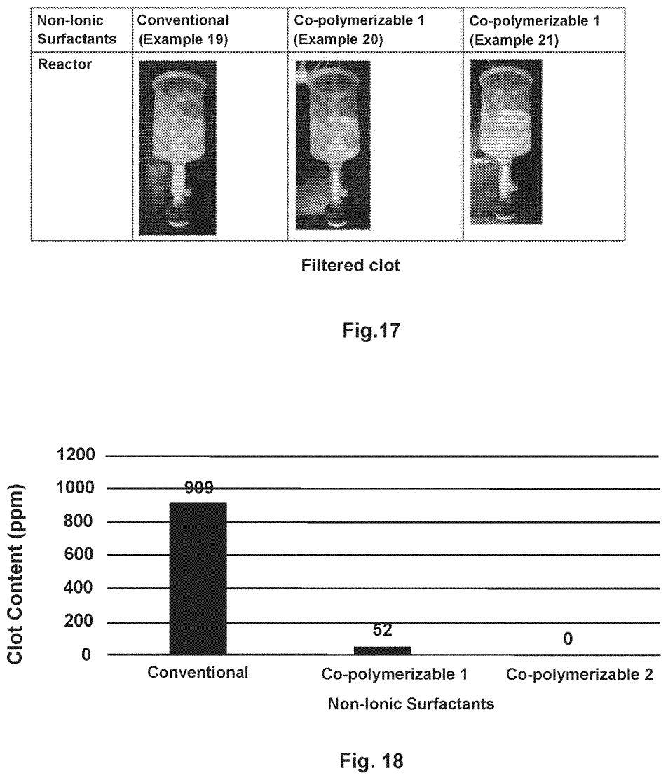

FIG. 10 shows the measured gloss at an angle of 60° of semi-gloss paints with PVC of approximately 26% containing latexes polymerized with different nonionic surfactants.

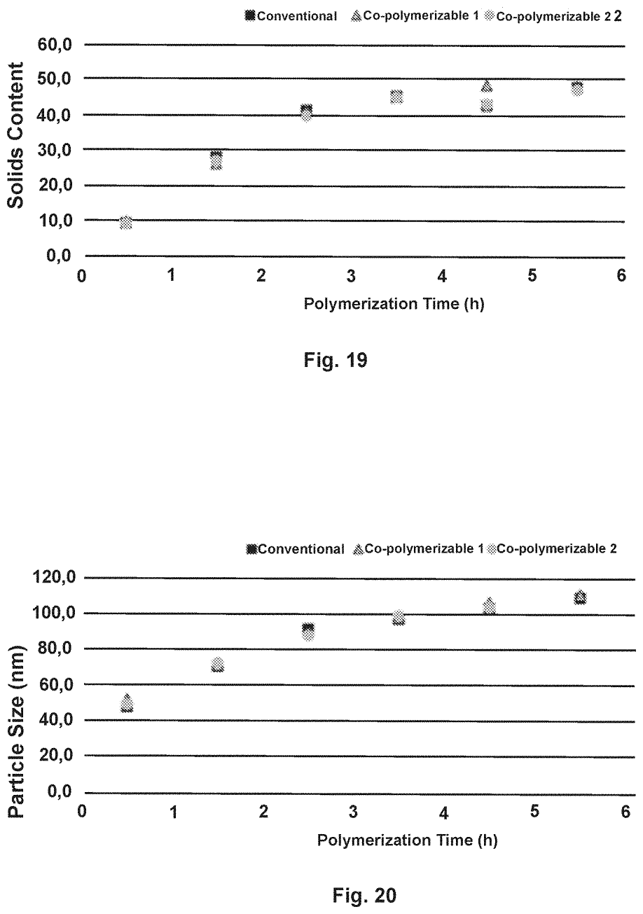

FIG. 11 shows a chart of the wet hiding power of semi-gloss paints with PVC of approximately 26% containing latexes polymerized with different nonionic surfactants.

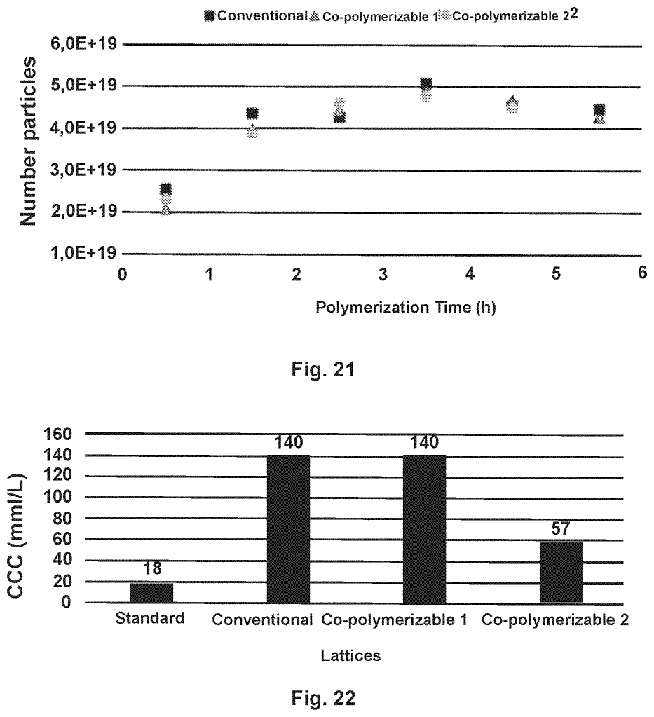

FIG. 12 shows a chart of the dry hiding power of semi-gloss paints with PVC of approximately 26% containing latexes polymerized with different nonionic surfactants.

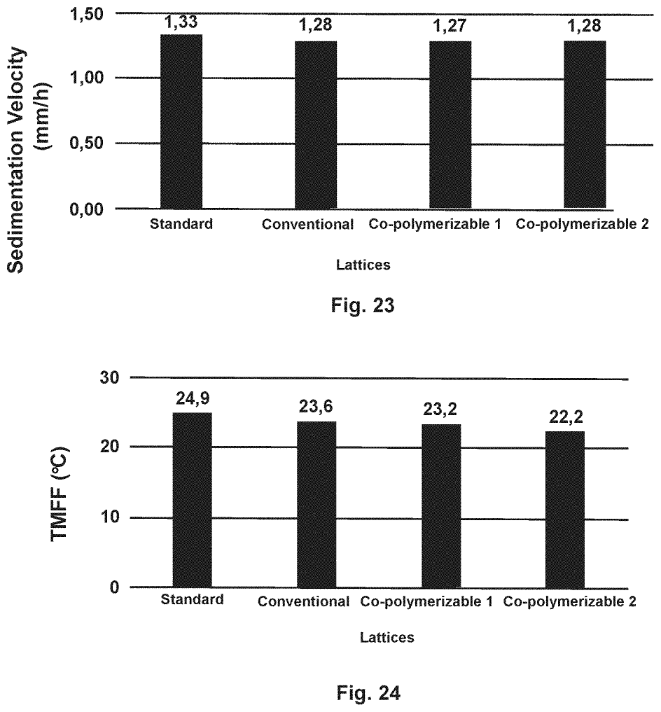

FIG. 13 shows the wet scrub resistance of semi-gloss paints with PVC of approximately 26% containing latexes polymerized with different nonionic surfactants.

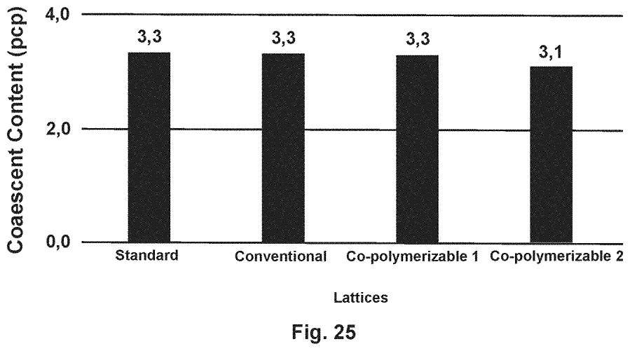

FIG. 14 shows the content of filtered clot in the latexes polymerized with different nonionic surfactants.

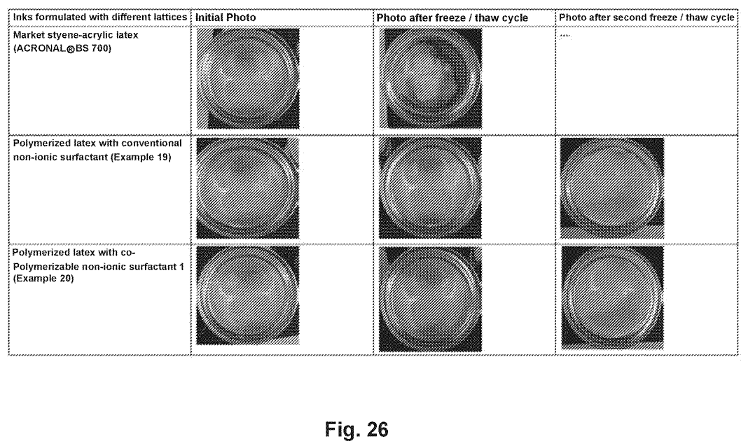

FIG. 15 shows the evolution of the solids content along the polymerization.

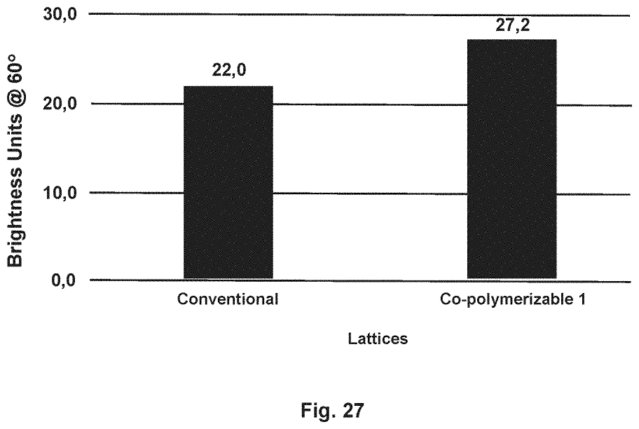

FIG. 16 shows the evolution of particle size along the polymerization.

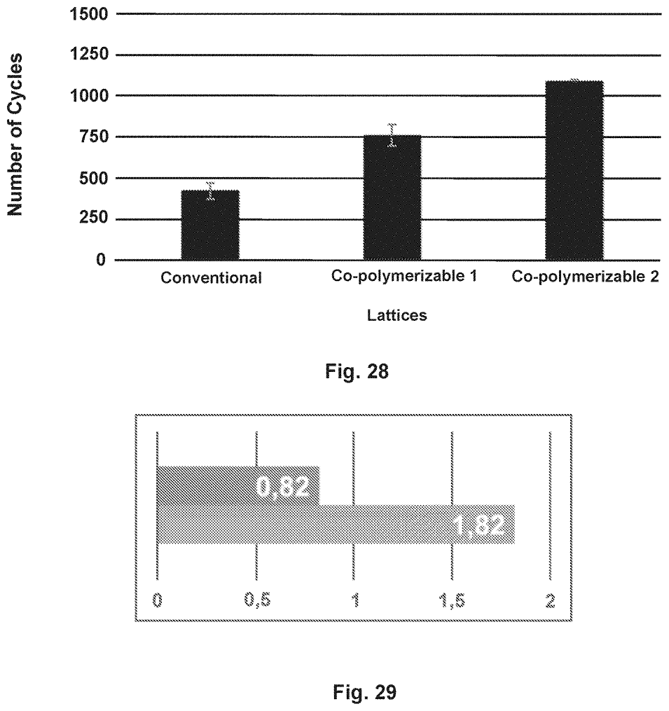

FIG. 17 shows the evolution of the number of particles along the polymerization.

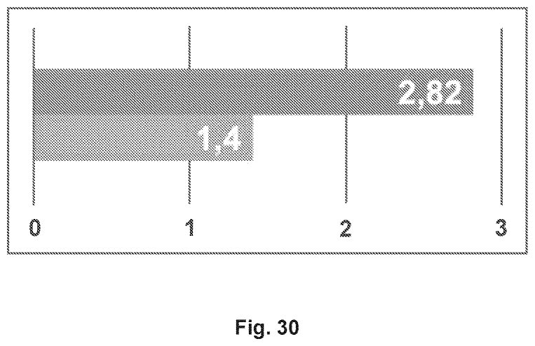

FIG. 18 shows the wet scrub resistance according to ASTM D2486 of semi-gloss paints with PVC of approximately 30% containing latexes polymerized with different nonionic surfactants.

### DETAILED INVENTION DESCRIPTION

The water-based coating compositions included in this invention are formulated with latexes polymerized with APE-free reactive nonionic surfactants.

Normally, coatings formulated with latexes polymerized with high conventional surfactant content have low resistance to water accessed through tests of wet scrub resistance of paints.

As an advantage, formulations containing latexes polymerized with conventional anionic surfactant and the APE-free reactive nonionic surfactants of the present invention showed an increase in wet scrub resistance of 80 to 200%, preferably 80 to 160%, in relation to paints formulated with latex polymerized with APE-free conventional nonionic surfactants.

Due to these advantages, the coating composition of the present invention can be used in decorative paints, construction paints, industrial paints, printing inks, toner, original automotive paints, repainting paints, adhesives, sealants, waterproofing agents, asphalt emulsions, gloves and carpets.

The monomer used in latex synthesis is preferably styrene, esters derived from acrylic acid, esters derived from methacrylic acid, acrylic acid, methacrylic acid, vinyl acetate, ethylene, acrylonitrile, butadiene, VEOVA™.

Styrene-acrylic latexes polymerized with APE-free conventional anionic surfactants and APE-free reactive nonionic surfactants showed conversion kinetics similar to latexes polymerized with conventional anionic and nonionic surfactants. The same behavior was seen for latexes polymerized only with acrylic monomers.

These results show that the APE-free reactive nonionic surfactants of this invention, besides presenting the advantages mentioned above, are not interfering negatively in the conversion and copolymerization of monomers into polymer, especially in the conversion and copolymerization of the styrene monomer which, as previously mentioned in document US 2014/0249272 A1, is critical for APE-free reactive surfactants.

The polymerization processes comprised in this invention allow the generation of stable and low foaming latexes throughout the polymerization process.

The anionic surfactants used in the preparation of latexes may be non-reactive and reactive, deriving from sulfate, sulfonate, sulfosuccinate and phosphate groups.

Also, the APE-free reactive nonionic surfactants comprised in this invention have unsaturation in the hydrophobic portion of the surfactant.

According to the literature, molecules with unsaturation in the hydrophobic part of the surfactant, allow the reactive surfactant to have a configuration on particle surface similar to that of conventional surfactants, wherein in the reactive surfactants the hydrophobic part reacts with monomers forming a covalent bond with the polymer, while in conventional surfactants the hydrophobic part only adsorbs on particle surface. In both surfactants, the hydrophilic part stays in contact with the water protecting the particles against flocculation or coagulation through electrostatic or steric stabilization.

The unsaturation of the APE-free reactive nonionic surfactants of this invention is in the terminal part of the hydrophobic chain and, therefore, it has superior reactivity as compared to conventional fatty acid-derived surfactants with unsaturation in the middle of the hydrophobic chain. As a result, such conventional fatty acid-derived surfactants have a low reactivity and potential to be effectively incorporated into the polymer. On the other hand, the APE-free reactive nonionic surfactants of the present invention are very reactive, they show a high potential to be incorporated into polymers and improve the water resistance of coating compositions.

Furthermore, the surfactant molecules of the present invention do not have the unsaturation in side groups like most commercial reactive surfactant molecules and molecules taught in document US 2014/0249272 A1. Molecules with unsaturation in side groups occupy a larger area per molecule and decrease the number of reactive surfactant molecules that adsorb at the polymer-water interface, decreasing their capacity to stabilize the polymer particles dispersed in water in relation to conventional surfactants.

As a result, the APE-free reactive nonionic surfactants claimed here also have a high potential to generate stable latexes.

In one implementation, the APE-free reactive nonionic surfactants of this invention are esters comprising a mixture of monoester and diester of unsaturated fatty acid with unsaturation at the end of the hydrophobic chain.

In addition to that, the APE-free reactive non-ionic surfactants of this invention can be obtained preferentially from reactions of alkoxylation of fatty acid with terminal unsaturation. The reactive nonionic surfactants of this invention can also be obtained from direct esterification of fatty acid with polyethylene glycol.

In addition to that, the APE-free reactive non-ionic surfactants of this invention can be obtained by direct transesterification of fatty ester with terminal unsaturation and polyethylene glycol or by transesterification of this fatty ester followed by alkoxylation

The direct esterification route of fatty acids with terminal unsaturation and glycol derivatives generates monoesters as described in the U.S. Pat. No. 10,100,137 B2 and its use in emulsion polymerization. However, the inventors did not reported neither improvement related to colloidal stability of latexes polymerized with monoester nor improvement in the wet scrub resistance of paints formulated with those latexes which surprisingly were identified in the present invention.

In this invention, latexes polymerized with monoester presented higher colloidal stability and generate coatings with 30 to 80% higher wet scrub resistance than coatings formulated with latexes polymerized with conventional non-ionic surfactants and latexes from the market.

The route of alkoxylation of fatty acid with terminal unsaturation generates a mixture of monoesters and diesters, presenting promising surface properties. Latexes polymerized with the APE-free reactive nonionic surfactants obtained from this route are stable and generate coatings with surprising wet scrub resistance, about 30-160% higher than coatings formulated with latexes polymerized with conventional non-ionic surfactants and latexes from the market. These unexpected results were not foreseen in open literature and patents, since most of the latexes are preferably polymerized with reactive anionic surfactants.

In a preferred implementation, the terminal unsaturated fatty acid used in this invention has 10 or 11 carbons, and in a more preferred implementation, the fatty acid is selected from 9-decenoic acid and 10-undecenoic acid.

In addition, in an even more preferred implementation, the APE-free reactive nonionic surfactant is prepared from the ethoxylation of 9-decenoic acid.

The examples that will be presented illustrate the potential of the APE-free reactive nonionic surfactants according to the present invention.

### EXAMPLES

The methods described below have been used to characterize the polymerizations, latexes and paints mentioned in the examples.

The conversion of monomers into polymer was monitored by determining the solids content according to the ASTM D2369-10 of the latex samples collected during polymerization, final acid latex and final neutralized latex.

The clot formation in the reactor was monitored by taking pictures of the reactor after the polymerization was completed.

The content of clot in the latex was estimated by filtering the latex from the reactor in a 200 Mesh previously weighed sieve, drying the sieve and residue for 3 hours in an oven at a temperature of 110±5° C., weighing the dry mass of the residue and estimating the content of clot according to ASTM D2369-10.

The particle size distribution of the diluted latex dispersions was determined by dynamic light scattering using the Zetasizer Nano ZS equipment.

The Brookfield viscosity of the latexes was determined according to ISO 1652.

The mechanical stability of the latexes was estimated according to ASTM D1417 by determining the content of the clot formed in latex maintained at 14000 rpm for 30 min.

The electrolytic stability was determined by titration of latex dispersion with a solid content of 0.1 wt % with 5 mol.L⁻¹ solution of CaCl₂ and measuring the particle size of latex samples. An average particle size chart is drawn as a function of CaCl₂ concentration. The CaCl₂ concentration at which there is an abrupt increase in the average particle size is the critical coagulation concentration (CCC).

The pH of the latexes and paints was determined according to ASTM E70.

The consistency of the paints was determined according to ASTM D562-10.

The rheological behavior of the paints was adjusted according to ASTM D7394.

The gloss of paints dried for 7 days at 25±2° C. and 50±5% relative humidity was evaluated according to ASTM D523-14.

The wet hiding power of the paints was evaluated according to ASTM D2805-11.

The dry hiding power of the paints dried for 7 days at 25±2° C. and 50±5% relative humidity was evaluated according to ASTM D2805-11.

The wet scrub resistance of the paints dried for 7 days at 25±2° C. and 50±5% relative humidity was evaluated according to ASTM D2486-17.

### Example 1: Ethoxylation

The fatty acid (9-decenoic acid, 9-DA, 800 g) was loaded into a Parr reactor. Potassium hydroxide 50 wt % solution (4 g) was used as a catalyst. The mixture was homogenized under stirring and then, vacuum and heating were initiated to remove the water. With the dry fatty acid, the vacuum was blocked, and the stirring was increased (800 rpm). With the system at 140° C., the ethylene oxide (EO, 2358 g) injection was started and the reaction temperature was maintained at 155° C. After the injection of all EO, the system pressure stabilization was awaited, ensuring the digestion of the entire oxide mass. A vacuum was then applied again at 120° C. to remove by-products, then cooled to a temperature below 90° C. and neutralized, obtaining 9-decenoic acid 12 EO. A similar procedure was performed to obtain the 23 EO variation of the same acid.

### Example 2: Transesterification

Into a 3-liter 4-necked round-bottomed flask equipped with mechanical agitator, condenser, thermocouple and nitrogen inlet, the raw materials for obtaining decenoate of polyethylene glycol that comprehends polyethylene glycol (ULTRAPEG 600, 1427 g), the fatty acid ester (methyl 9-decenoate, 9-DAME, 584 g) and potassium hydroxide in flakes as a catalyst (14 g) were loaded. A stirring of 700 rpm and temperature of 170° C. was maintained, with a light vacuum to facilitate the methanol removal. The reaction time to reach stabilized hydroxyl index and remove the theoretical methanol (˜130 mL) was approximately 18 hours. The system was cooled to 50-60° C. and the neutralization was performed.

### Example 3: Transesterification Followed by Ethoxylation

Into a 3-liter 4-necked round-bottomed flask equipped with mechanical agitator, condenser, thermocouple and nitrogen inlet, the raw materials for esterification and production of monoethylene glycol decenoate that comprehends monoethylene glycol (MEG, 497 g), the fatty acid ester (methyl 9-decenoate, 9-DAME, 1358 g) and potassium hydroxide in flakes as a catalyst (32 g) were loaded. A stirring of 700 rpm and temperature of 140° C. were maintained. The reaction time to reach stabilized hydroxyl index and remove the theoretical methanol (˜315 mL) was approximately 12 hours. The system was cooled to 50-60° C. and the neutralization was performed.

The monoethylene glycol decenoate then proceeded to the Parr reactor and an ethoxylation procedure similar to Example 2 was performed, ensuring the injection of 11 moles of EO to obtain the product similar to decenoic acid 12 EO.

### Example 4: Characterization of the Ethoxylation Route

The approximate composition of the monoester and diester mixture, analyzed by HPLC for the ethoxylation route (12 and 23 EO) is shown in Table 1. The concentration of each component was estimated based on its respective percentage of area on the chromatogram:

TABLE 1
Composition of products obtained by the ethoxylation route.

| Components | % by weight |
|---|---|
| Monoester | 60-70 |
| Diester | 30-40 |

Table 2 shows the molecular weights of the products obtained by ethoxylation routes (Example 1). These molecular weights were obtained via LC/MS.

TABLE 2
Molecular weight of products obtained
by the ethoxylation route (Example 1).

| | Ethoxylated acid 12 | Ethoxylated acid 23 |
|---|---|---|
| | EO | EO |
| Sample | Example 2 | Example 2 |
| MONOESTER | 628-672-716 | 980-1024-1068 |
| | Apex 716 | Apex 1068 |
| DIESTER | 868-912-956 | 1132-1176-1220 |
| | Apex 956 | Apex 1176 |

### Example 5: Comparative Characterization of Transesterification Routes

The products of the unsaturated fatty acid ethoxylation route with monoester/diester ratios ranging from 1.5 to 2.5 presented surprising results in the application, probably due to the presence of the diesters. Due to those results, alternative routes starting from the unsaturated fatty acid methyl ester have been developed in examples 2 and 3 in order to generate compositions and molecular weights similar to the ethoxylation of unsaturated fatty acid.

Table 3 below shows a comparison of the molecular weights, comparing the invention reference (acid route, Example 1) with the one that has been obtained via transesterification of the fatty acid ester, such as the monoester/diester ratios obtained so far. The results presented in Table 3 pave the way for transesterification (either pure or followed by ethoxylation) as an alternative route to obtain the invention molecule.

TABLE 3
Characterization of the products obtained
in Example 1, Example 2 and Example 3.

| | | | Transesterifi- |
|---|---|---|---|
| | | | cation route |
| | | Transesterifi- | followed by |
| | Acid Route | cation Route | ethoxylation |
| Sample | Example 1 | Example 2 | Example 3 |
| MONOESTER | 628-672-716 | Apex 716 | Apex 716 |
| | Apex 716 | | |
| DIESTER | 868-912-956 | Apex 868 | Apex 824 |
| | Apex 956 | | |
| MONO/DI RATIO | 1.5-2.5 | 1.7-2.4 | 1.8-2.1 |

Based on these characterizations presented in Table 3 the composition of reactive nonionic surfactants obtained from ethoxylation of monounsaturated fatty acid, transesterification of monounsaturated fatty ester and transesterification of monounsaturated fatty ester followed by ethoxylation, presented in Examples 1-3, comprises a mixture of monoester and diester with ratio of monoester to diester ranging from 1 to 3. The composition containing 12 mols of EO, obtained in the Examples 1-3, is named as REACT 1 and it will be used in the examples of application of the reactive nonionic surfactant in emulsion polymerization.

### Example 6: Esterification

Into a 3-liter 4-necked round-bottomed flask equipped with mechanical agitator, condenser, thermocouple and nitrogen inlet, the raw materials for esterification and production of methanol decenoate 12 EO were loaded. The polyethylene glycolic derivative (methoxypolyethylene glycol, MPEG 500, 1108 g), fatty acid (9-decenoic acid, 9-DA, 329 g), hypophosphorous acid (14 g) and methane sulfonic acid (MSA, 10 g) were loaded. A stirring of 700 rpm, vacuum and 140° C. temperature was maintained. The reaction time to achieve stabilized acidity index and remove the theoretical water (˜35 mL) was about 15 hours. The system was cooled to 50-60° C. and the neutralization was performed. Next, the sample was dried again with a vacuum at 130° C. to remove the water from the neutralization. Methanol decenoate 12 EO obtained is protected in the U.S. Pat. No. 10,100,137 B2, named as Standard Reactive, and it will be used as a standard its properties will be compared to REACT 1.

### Example 7: Esterification Route Characterization

The esterification routes presented in Example 6, generated products with the following approximate composition of monoester and diester mixture analyzed by HPLC (Table 4). The concentration of each component was estimated based on its respective percentage of area on the chromatogram:

TABLE 4
Monoester and diester contents obtained by HPLC.

| Components | % by weight |
|---|---|
| Monoester | >99 |
| Diester | Traces |

The estimated molecular weight of the products obtained through different characterization techniques is presented in Table 5 below:

TABLE 5
Molecular weight estimated by different
characterization techniques.

| | METHANOL |
|---|---|
| Molecular Weight/Sample | DECENOATE 12 EO |
| Calculated by the saponification index | 718 |
| Calculated by the Iodine Index | 687 |
| Calculated by GPC | 729 |

### Example 8

Example 8 shows the properties related to the surface activity of REACT 1 synthesized in Example 1. These properties of REACT 1 were compared to the ones of a conventional nonionic surfactant and the Standard Reactive, protected in U.S. Pat. No. 10,100,137 B2, synthesized in Example 6. Curves of surface tension as a function of surfactant concentration are presented in FIG. 1 and the critical micelle concentration (CMC) and surface tension at CMC is presented in Table 6.

TABLE 6
Critical micelle concentration (CMC) and surface tension at CMC.

| Nonionic Surfactants | CMC (g/L) | Surface Tension (mN/m) |
|---|---|---|
| Conventional | 230 | 43 |
| Standard Reactive | 1300 | 35 |
| REACT 1 | 59 | 34 |

FIG. 1 and Table 6 show that REACT 1 has lower CMC and surface tension at CMC than the conventional nonionic surfactant. Moreover, REACT 1 has lower CMC than the Standard Reactive. According to these results, REACT 1 behaves as a conventional surfactant before its copolymerization being more hydrophobic and efficient for adsorbing and packing at air-water interface than the conventional nonionic surfactant and the Standard Reactive. Moreover, due to its higher hydrophobicity, REACT 1 should be more compatible with hydrophobic latexes used in coatings than the Standard Reactive.

### Example 9

131.3 g demineralized water, 0.1 g sodium bicarbonate and 2.1 g sodium salt of lauryl ether sulphate (30 wt %) and 2.0 g of conventional nonionic surfactant (OXITIVE 7110, fatty alcohol with 23 moles of ethylene oxide and 60 wt %) were loaded into the reactor. This was stirred at 300 rpm and warmed to reach a temperature of 80° C. The reactor used was a 1 L glass reactor, OPTIMAX 300 from Mettler Toledo, equipped with a reflux condenser, a stirrer and a thermocouple.

Simultaneously, a pre-emulsion containing 127.4 g demineralized water, 12.6 g of sodium salt of lauryl ether sulfate (30 wt %), 11.8 g of conventional nonionic surfactant (OXITIVE 7110, fatty alcohol with 23 moles of ethylene oxide and 60 wt %), 164.3 g styrene, 138.0 g butyl acrylate and 6.6 g acrylic acid and initiator solution containing 32.8 g water and 1.0 g potassium persulfate were prepared.

When the reaction temperature of the medium reached 80° C., 5 wt % of the pre-emulsion and 5 wt % of the initiator solution were added to the reactor and the polymerization medium was maintained at a temperature of 80-85° C. under 300 rpm stirring for 30 minutes. This stage of polymerization included the seeds nucleation.

After finishing the nucleation step, 95% of the pre-emulsion was added to the reactor using a peristaltic pump for 3.5 hours at a flow rate of approximately 2.1 g/min. Simultaneously, 95% of the initiator solution was added to the reactor using a peristaltic pump for 4.0 hours with an approximate flow rate of 0.1 g/min.

Latex samples were collected from the reactor after 0.5, 1.5, 2.5, 3.5 and 4.5 hours of polymerization to monitor the conversion of monomer into polymer and the average particle size.

After finishing the initiator solution addition, the temperature of the reactional medium was maintained at 80-85° C. for 0.5 hours and subsequently lowered to 60° C. Simultaneously, an oxidising solution containing 9.9 g of water and 0.1 g of Trigonox AW 70 (tert-butyl hydroperoxide in water with 70 wt %) and a reducing solution containing 9.9 g of water and 0.1 g of SFS (Sodium formaldehyde sulfoxylate) were prepared.

Those solutions were added with a flow rate of approximately 0.2 g/min into the reactor containing latex at a temperature of 60° C. for 1 hour in order to favor the conversion of the residual monomer into polymer.

After the addition of the oxidizing and reducing solutions, the polymerization was maintained for another 1 hour at a temperature of 60-65° C.

After this step, the temperature of the medium was lowered to 50° C. and the obtained latex was discharged from the reactor and filtered through a 200 Mesh sieve to quantify the content of clot dispersed in the latex.

The theoretical mass of latex should be 650 g. This theoretical latex mass does not take into account samples collected to monitor the process and latex losses to the reactor and impeller walls as well as losses occurring during latex filtration.

### Example 10

The latex in Example 10 was prepared following the procedure described in Example 9, replacing the asset mass of the conventional nonionic surfactant by the equivalent asset mass of the Standard Reactive (experimental sample obtained in Example 6 with 99.6 wt %). Masses of demineralized water charged into the reactor and of the pre-emulsion were adjusted to 132.1 g and 132.3 g, respectively, to keep the theoretical mass of latex at 650 g.

### Example 11

Example 11 was prepared following the procedure described in Example 9 by replacing the conventional nonionic surfactant asset mass with the equivalent asset mass of the REACT 1 (experimental sample obtained according to the route described in Example 1 with 99.0 wt %). Masses of demineralized water charged into the reactor and the pre-emulsion were adjusted to keep the theoretical mass of latex at 650 g.

### Example 12

The effect of the different nonionic surfactants on the clot formation in the reactor is shown in FIG. 2.

The reactor photos obtained after filtering the latex show that the latexes polymerized with reactive nonionic surfactants produced a low level of dirt in the reactor, similar to the level of dirt generated by the latex polymerized with conventional nonionic surfactant.

### Example 13

The effect of different nonionic surfactants used in polymerization on the clot content obtained in latex filtration is shown in FIG. 3.

According to FIG. 3, latexes polymerized with the reactive nonionic surfactants formed much less clot during polymerization than latex polymerized with conventional nonionic surfactant.

### Example 14

The latexes obtained in examples 9, 10 and 11 have a pH around 2 and the clot contents formed during their neutralization with MEA (monoethanolamine) until reaching a pH between 8.5 and 9.0 are shown in FIG. 4.

In the neutralization stage, there is an increase in the concentration of electrolytes in the medium, especially in the points of latex that initially come into contact with the neutralizer, considerably increasing the ionic strength of the medium and the tendency of the particles to coagulate. At this stage of the process, the nonionic surfactant plays a key role in preventing the coagulation of latex particles.

The results of clot content formed during neutralization, presented in FIG. 4, demonstrate that the latexes polymerized with the reactive nonionic surfactants formed less clot in the neutralization step than the latex polymerized with the conventional nonionic surfactant. Consequently, latexes polymerized with reactive nonionic surfactants have a higher electrolytic resistance than the latex polymerized with conventional nonionic surfactant.

### Example 15

The effect of different nonionic surfactants on the conversion of monomers into polymer is shown in FIG. 5. The conversion of monomers into polymer was monitored by assessing the solids content of the latex samples collected throughout the process. The results presented in FIG. 5 demonstrate that conventional and reactive nonionic surfactants favored the conversion of monomers into polymer. This tendency of results shows that reactive nonionic surfactants, which are unprecedented molecules, have not delayed the conversion of monomers into polymer.

### Example 16

The effect of different nonionic surfactants on the latex particle size throughout polymerization is shown in FIG. 6. The evolution of the latex particle size was monitored by performing particle size analyses of the latex samples taken throughout the process. The size of latex particles depends on the number of nucleated particles and the stabilization of these particles by the anionic and nonionic surfactants and hydrophilic groups present on the surface of the particles which are preferably sulfate end-groups from the persulfate initiator and carboxylic groups from carboxylic acid derived monomers. The results of particle size evolution show that the reactive nonionic surfactants were as efficient to stabilize the growing latex particles along the polymerization as the conventional nonionic surfactant.

### Example 17

The effect of different nonionic surfactants on the evolution of the number of latex particles along the polymerization is shown in FIG. 7. The number of particles was estimated by dividing the polymer volume, estimated from the solids content, by the volume of the particle, estimated from the particle radius. The tendency of the particle number evolution for all polymerizations containing the different nonionic surfactants were close. These tendencies showed that an increase in particle number occurred after the particle nucleation step indicating that new particles were nucleated. This increase in the number of particles occurred over a longer period for the conventional nonionic surfactant. After this period of increase in the number of particles there was a decrease in the number of particles for all polymerizations. These results in FIG. 7 suggest that the reactive nonionic surfactants allowed a better control of the number of particles than the conventional nonionic surfactant.

### Example 18

The general properties of the latexes polymerized with the different nonionic surfactants are presented in Table 7.

TABLE 7
General latex properties.

| | | Solids | Particle | | Superficial |
|---|---|---|---|---|---|
| Nonionic | | Content | size | Viscosity | Tension |
| surfactants | pH | (%) | (nm) | (cP, 25° C.) | (mN/m) |
| Conventional | 8.8 | 47 | 122 | 202 | 39 |
| Standard Reactive | 8.5 | 46 | 143 | 54 | 39 |
| REACT 1 | 8.5 | 50 | 128 | 280 | 37 |

Those results show that the latexes polymerized with the different nonionic surfactants had a high solid content, i.e., solid content greater than 45 wt %, particle size between 120 and 150 nm, viscosity less than 300 cP and surface tension between 35 and 40 mN/m.

### Example 19

The effect of the different nonionic surfactants on the mechanical stability of the latexes is presented in FIG. 8. The clot contents formed in the latexes maintained in shear of 14,000 rpm for 30 min showed that the conventional nonionic surfactant and Standard Reactive nonionic surfactant presented similar mechanical stability while the REACT 1 presented superior mechanical stability forming 5 times less clot than the latexes polymerized with conventional nonionic surfactant and Standard Reactive nonionic surfactant. Such greater stability is related to the incorporation of this surfactant into the polymer and its stabilization capacity in relation to conventional nonionic surfactant and Standard Reactive nonionic surfactant.

### Example 20

The electrolytic stability of a benchmark styrene-acrylic latex, Acronal® BS 700, and latexes polymerized with anionic surfactant and different nonionic surfactants of Examples 9-11 is presented in FIG. 9. FIG. 9 shows the critical coagulation concentration (CCC) of CaCl₂ required to coagulate the latex particles. The higher that concentration, the greater the latex stability.

According to FIG. 9, the latex polymerized with conventional nonionic surfactant showed greater stability to CaCl₂ than latexes polymerized with reactive nonionic surfactants. The latexes polymerized with reactive nonionic surfactants showed greater stability to CaCl₂ than benchmark latex. These CCC results suggest that latex polymerized with conventional nonionic surfactant showed a more effective steric stabilization than latex polymerized with reactive nonionic surfactants, probably, due to the fact that reactive nonionic surfactant molecules cab be partially buried inside the particles.

### Example 21

Also, the effect of latexes polymerized with different nonionic surfactants on the properties of semi-gloss paints was verified. The latexes obtained in Examples 9, 10 and 11 were formulated in semi-gloss paints together with the components presented in Table 8.

TABLE 8
Semi-gloss paint formulation.

| Components | % Mass |
|---|---|
| Potable Water | 9.25 |
| Sodium Nitrite | 0.03 |
| Sodium Tetrapirophosphate | 0.05 |
| Hydroxyethyl cellulose | 0.15 |
| Propylene glycol | 1.50 |
| Monoethanolamine | 0.05 |
| Sodium Polyacrylate | 0.35 |
| Nonionic Surfactant | 0.15 |
| Anti-foaming agent | 0.10 |
| Bactericide | 0.15 |
| Fungicide | 0.05 |
| Titanium Dioxide | 21.50 |
| Kaolin - Aluminium Silicate | 3.50 |
| Precipitated Calcium Carbonate | 1.50 |
| Total Mass (g) | 38.3 |
| Latex | 42.50 |
| Antifoaming agent | 0.25 |
| ULTRAFILM ® 5000 | 1.70 |
| Monoethanolamine | 0.40 |
| Rheological Modifier (high shear) | 1.80 |
| Acrylic Thickener (low shear) | 0.30 |
| Completion potable water | 14.72 |
| Total | 100.00 |

The rheological behavior of the paints was adjusted by diluting thickener with completion water in the ratio of 1:1. The KU viscosity was adjusted to 80 KU by adding suitable acrylic thickener to adjust the rheological behavior of the paint at low shear rate. The ICI viscosity was adjusted to 50-80 cP by adding suitable acrylic thickener to adjust the rheological behavior of paint at a high shear rate, around 11000 s′. The thickener contents used to adjust the rheological behavior and viscosities of the paints at low, medium and high shear rates are presented in Tables 9 and 10, respectively.

TABLE 9
Thickener contents used to adjust the rheological behavior
of paints formulated with latexes polymerized with conventional
nonionic surfactant, Standard Reactive and REACT 1.

| | Latexes polymerized with different nonionic surfactants | | |
|---|---|---|---|
| Thickeners | Conventional | Standard Reactive | REACT 1 |
| Low shear rate | 0.3 | 0.6 | 0.4 |
| High shear rate | 1.8 | 1.4 | 1.7 |

Table 9 shows that it was necessary to use a total thickener content of around 2% to adjust the rheological behavior of the paints formulated with the different latexes.

According to Table 10, the paint viscosities obtained were between 1200-1500 cP at low shear rate, 250-350 cP at medium shear rate and 56-70 cP at high shear rate.

TABLE 10
Low, medium and high shear viscosities of paints formulated
with latexes polymerized with different nonionic surfactants.

| | Viscosity (cP) | | |
|---|---|---|---|
| Latexes | 50 s−1 | 500 s−1 | 11000 s−1 |
| Conventional nonionic surfactant | 1384 | 284 | 56 |
| Standard Reactive | 1278 | 334 | 61 |
| REACT 1 | 1423 | 327 | 70 |

The pH and KU viscosity values of the paints aged at 25° C. for 1 day are shown in Table 11.

TABLE 11
pH and KU viscosity of paints formulated with latexes
polymerized with different nonionic surfactants.

| Latexes | pH | Viscosity (KU) |
|---|---|---|
| Conventional nonionic surfactant | 9.5 | 102 |
| Standard Reactive | 9.3 | 105 |
| REACT 1 | 9.1 | 106 |

The gloss results of the paints formulated with latexes polymerized with different nonionic surfactants are presented in FIG. 10.

According to FIG. 10, all the paints formulated with the different latexes had a gloss greater than 30 units of gloss and the paints formulated with the latexes polymerized with the conventional nonionic surfactant and REACT 1 had a slightly greater gloss than the paints formulated with the latexes polymerized with the Standard Reactive nonionic surfactant.

The results of wet and dry hiding power of the paints formulated with latexes polymerized with different nonionic surfactants are presented in FIG. 11 and FIG. 12, respectively.

The wet and dry hiding power of the semi-gloss paints formulated with latexes polymerized with different nonionic surfactants were similar. These results suggest that latexes polymerized with different nonionic surfactants are not affecting the distribution patterns of pigments and fillers in wet and dry paint films.

The wet scrub resistance results of the paints formulated with latexes polymerized with different nonionic surfactants are presented in FIG. 13.

According to FIG. 13, paints formulated with latex polymerized with reactive nonionic surfactants showed a 30% greater wet scrub resistance than paints formulated with latex polymerized with conventional nonionic surfactant. These results validate that paints formulated with reactive nonionic surfactants have a higher water resistance than paints formulated with conventional nonionic surfactants.

### Example 22

131.5 g demineralized water, 0.1 g sodium bicarbonate and 3.9 g sodium salt of lauryl ether sulfate (30 wt %) were charged into the 1 L glass reactor. This was stirred at 300 rpm and warmed to reach a temperature of 80° C. The used reactor was the same described in Example 9 (OPTIMAX).

Simultaneously, pre-emulsions containing 126.8 g demineralized water, 22.8 g sodium salt of lauryl ether sulfate (30 wt %), 25.1 g conventional nonionic surfactant (OXITIVE 7110, fatty alcohol with 23 moles of ethylene oxide and 60 wt %), 151.6 g styrene, 128.7 g butyl acrylate and 5.7 g acrylic acid and initiator solution containing 32.9 g water and 0.9 g potassium persulfate were prepared.

When the reactor reached a temperature of 80° C., 5 wt % of the pre-emulsion and 5 wt % of the initiator solution were added to the reactor and the reaction medium was maintained at a temperature between 80 and 85° C. under stirring of 300 rpm for 30 minutes. This stage of polymerization comprises the seeds nucleation.

After completion of the nucleation step, 95 wt % of the pre-emulsion was added to the reactor using a peristaltic pump for 3.5 hours with a flow rate of approximately 2.1 g/min. Simultaneously, 95 wt % of the initiator solution was added to the reactor using a peristaltic pump for 4.0 hours with an approximate flow rate of 0.1 g/min.

Latex samples were taken from the reactor after 0.5, 1.5, 2.5, 3.5 and 4.5 hours of polymerization to monitor monomer to polymer conversion and average particle size.

After finishing the addition of initiator solution, the temperature of the reaction medium was maintained at 80-85° C. for 0.5 hour and subsequently lowered to 60° C. Simultaneously, an oxidizing solution containing 9.9 g water and 0.1 g Trigonox AW 70 (tert-butyl hydroperoxide in water with 70 wt %) and a reducing solution containing 0.1 g SFS (Sodium formaldehyde sulfoxylate) were prepared.

These solutions were added with an approximate flow rate of 0.2 g/min to the reactor containing latex at a temperature of 60° C. for 1 hour in order to favor the conversion of the residual monomer into polymer.

After the addition of the oxidizing and reducing solutions, the polymerization was maintained for another 1 hour at a temperature of 60-65° C.

After this step, the temperature of the medium was lowered to 50° C. and the resulting latex was discharged and filtered through a 200 mesh sieve to quantify the content of clot dispersed in the latex.

The theoretical mass of latex should be 650 g. That theoretical latex mass does not take into account samples taken to monitor the process and latex losses to the reactor and impeller walls as well as losses occurring during latex filtration.

### Example 23

According to this invention, Example 23 was prepared following the procedure described in Example 22 by replacing the asset mass of the conventional nonionic surfactant with the equivalent asset mass of the Standard Reactive (experimental sample obtained in Example 6 with 99.6 wt). Initial demineralized and pre-emulsion water masses were adjusted to maintain the theoretical latex mass at 650 g.

### Example 24

According to this invention, Example 24 was prepared following the procedure described in Example 22 by replacing the asset mass of the conventional nonionic surfactant with the equivalent asset mass of the REACT 1 (experimental sample obtained according to the route described in Example 1 with 99.0% of assets). Masses of demineralized water loaded into the reactor and the pre-emulsion were adjusted to maintain the theoretical mass of latex at 650 g.

### Example 25

The effect of the different nonionic surfactants used in the polymerization of the latexes in Examples 22, 23 and 24 on the clot content obtained in filtration is shown in FIG. 14.

According to FIG. 14, latexes polymerized with reactive nonionic surfactants have a much lower clot content than latex polymerized with conventional nonionic surfactant.

### Example 26

The effect of different nonionic surfactants on the conversion of monomers into polymer is shown in FIG. 15. The results presented in FIG. 15 demonstrate that the conventional and reactive surfactants used in the polymerizations of Examples 22, 23, 24 favored the conversion of monomers into polymer. These results together with the results of Example 15 demonstrate that the reactive surfactants did not delay the conversion of the monomer into polymer.

### Example 27

The effect of the different nonionic surfactants of the latexes in Examples 22, 23 and 24 on particle size along the polymerizations is shown in FIG. 16. The results of particle size evolution show that the reactive nonionic surfactants were as efficient as the conventional nonionic surfactant in stabilizing the growing latex particles along the polymerizations.

### Example 28

The effect of different nonionic surfactants on the evolution of the particle number along the polymerizations of the latexes in Examples 22, 23 and 24 is shown in FIG. 17. The tendency of the particle number evolution for all polymerizations containing the different nonionic surfactants were similar.

### Example 29

The general properties of the latexes polymerized with the different nonionic surfactants in Examples 22, 23 and 24 are presented in Table 12.

TABLE 12
General latex properties

| | Solids | Particle | | Superficial |
|---|---|---|---|---|
| | Content | size | Viscosity | Tension |
| Nonionic Surfactants | (%) | (nm) | (cP, 25° C.) | (mN/m) |
| Conventional | 48 | 110 | 112 | 39 |
| Standard Reactive | 47 | 107 | 75 | 37 |
| REACT 1 | 47 | 107 | 78 | 36 |

These results show that all the latexes polymerized with the different nonionic surfactants had a solid content higher than 45%, particle size between 107 and 110 nm, viscosity lower than 200 cp and surface tension between 35 and 40 mN/m.

### Example 30

The latexes obtained in Examples 22, 23 and 24 were formulated in semi-gloss paints together with the components presented in Table 13 and the effect of the different nonionic surfactants used in the polymerizations of those latexes on the properties of the semi-gloss paints are presented below.

TABLE 13
Formulation of semi-gloss paint with 30% PVC.

| Components | % Mass |
|---|---|
| Potable Water | 9.25 |
| Sodium Nitrite | 0.03 |
| Sodium Tetrapirophosphate | 0.05 |
| Hydroxyethyl cellulose | 0.15 |
| Propylene glycol | 1.50 |
| Monoethanolamine | 0.05 |
| Sodium Polyacrylate | 0.35 |
| Nonionic surfactant | 0.15 |
| Anti-foaming agent | 0.10 |
| Bactericide | 0.15 |
| Fungicide | 0.05 |
| Titanium Dioxide | 21.50 |
| Kaolin - Aluminium Silicate | 3.50 |
| Precipitated Calcium Carbonate | 1.50 |
| Total mass (g) | 38.33 |
| Latex | 35.00 |
| Antifoaming agent | 0.25 |
| ULTRAFILM ® 5000 | 2.00 |
| Monoethanolamine | 0.40 |
| Rheological Modifier (high shear) | 2.10 |
| Acrylic Thickener (low shear) | 1.10 |
| Potable water | 20.82 |
| Total | 100.00 |

The KU viscosity of paints aged at 25° C. for 1 day are shown in Table 14.

TABLE 14
The KU viscosity of the paints formulated with
latexes polymerized in Examples 22, 23 and 24.

| Latex | Viscosity (KU) |
|---|---|
| Conventional nonionic surfactant (Example 22) | 102 |
| Standard Reactive nonionic surfactant (Example 23) | 105 |
| REACT 1 (Example 24) | 107 |

The wet scrub resistance results of paints formulated with latexes polymerized with different nonionic surfactants are presented in FIG. 18.

According to FIG. 18, latexes polymerized with reactive nonionic surfactants increased the wet scrub resistance of the paints by 80 to 160% as compared to latex polymerized with conventional nonionic surfactant.

The wet scrub resistance results presented in Examples 21 and 30 prove that the water-based coating formulations formulated with latexes polymerized with the novel reactive nonionic surfactant, REACT 1, described in this invention improve the water resistance of the paint formulations up to 200% in relation to the ones containing latex polymerized with conventional nonionic surfactant. Besides, those latexes have excellent colloidal stability forming less clot in the reactor, in the filtration step and in the latex neutralization step.

1.-14. (canceled)

15. An APE-free reactive nonionic surfactant, characterized in that it comprises monoesters and diesters with a ratio of monoester to diester ranging from 1 to 3, wherein the surfactant comprises a terminal unsaturation in the hydrophobic part and wherein the surfactant is derived from fatty acid with terminal unsaturation.

16. Surfactant according to claim 15, characterized in that it does not have unsaturation in side groups.

17. Surfactant according to claim 15, characterized in that it is 9-decenoic acid 12 EO or 9-decenoic acid 23 EO.

18. A process to obtain the APE-free reactive nonionic surfactant as defined in claim 15, characterized in that it comprises the stage of alkoxylation of fatty acid with terminal unsaturation or direct esterification of fatty acid with terminal unsaturation and glycol derivative or transesterification of fatty acid ester with terminal unsaturation and glycol derivative or transesterification of fatty acid ester with terminal unsaturation followed by ethoxylation.

19. Process according to claim 18, characterized in that the fatty acid with terminal unsaturation has 10 or 11 carbons.

20. Process according to claim 18, characterized in that the fatty acid is 9-decenoic acid and 10-undecenoic acid.

21. Process according to claim 18, characterized in that it comprises the ethoxylation of 9-decenoic acid.

22. Emulsion polymerized latexes, characterized in that they are polymerized with an anionic surfactant and an APE-free nonionic reactive surfactant as defined in claim 15.

23. Latexes according to claim 22, characterized in that the anionic surfactants are non-reactive and reactive, derived from sulfate, sulfonate, sulfosuccinate and phosphate groups.

24. Latexes according to claim 22, characterized in that the monomer used in latex synthesis is preferably styrene, esters derived from acrylic acid, esters derived from methacrylic acid, acrylic acid, methacrylic acid, vinyl acetate, ethylene, acrylonitrile, butadiene, VEOVA™.

25. A water-based coating composition with high water resistance, characterized in that it comprises emulsion polymerized latexes as defined in claim 22.

26. Use of the water-based coating composition as defined in claim 25, characterized in that it is in decorative paints, construction paints, industrial paints, printing inks, toner, original automotive paints, repainting paints, adhesives, sealants, waterproofing agents, asphalt emulsions, gloves and carpets.

27. A water-based coating composition with high water resistance, characterized in that it comprises latexes polymerized with an anionic surfactant and a reactive non-ionic surfactant based on monoester of C10-11 fatty acids with unsaturation in terminal carbon and alkylpolyethylene glycol with moles of EO ranging from 1 to 100.

28. Use of the water-based coating composition as defined in claim 27, characterized in that it is in decorative paints, construction paints, industrial paints, printing inks, toner, original automotive paints, repainting paints, adhesives, sealants, waterproofing agents, asphalt emulsions, gloves and carpets.
